(19) United States
(12) Patent Application Publication
(10) Pub. No.: US 2025/0350323 A1
(43) Pub. Date: Nov. 13, 2025

(54) IN-BAND WIRELESS CONTROL OF RECONFIGURABLE INTELLIGENT SURFACES

(71) Applicant: NEC Laboratories Europe GmbH, Heidelberg (DE)

(72) Inventors: Andres Garcia Saavedra, Heidelberg (DE); Vincenzo Sciancalepore, Heidelberg (DE); Marco Rossanese, Heidelberg (DE); Joerg Widmer, Leganés (Madrid) (ES); Sai Pavan Deram, Leganés (Madrid) (ES)

(21) Appl. No.: 19/206,077

(22) Filed: May 13, 2025

(30) Foreign Application Priority Data
May 13, 2024 (EP) 24175463

(51) Int. Cl. H04B 7/04; H04B 7/0456; H04L 5/00; H04L 27/26

(52) U.S. Cl. CPC H04B 7/04013; H04B 7/0456; H04L 5/0007; H04L 27/2636

(57) ABSTRACT

A computer-implemented method for enabling a base station (BS) to provide configuration commands wirelessly to a reconfigurable intelligence surface (RIS) includes establishing a new codebook for each configuration from a previous set of configurations. The method further includes generating an RIS control message based on embedding amplitude-modulated (AM) signals into Orthogonal Frequency-Division Multiplexing (OFDM) signals using the new codebook and providing the RIS control message to the RIS to control the RIS. The method can be used to optimize and/or allow enhanced decision making for controlling the RIS using the BS. For instance, the method can synchronize its radio scheduler decisions and the optimization of the RIS configuration seamlessly and/or disguise RIS control messages into New Radio OFDM symbols. In some embodiments, machine learning (ML) and/or artificial intelligence (AI) techniques (e.g., a neural network (NN)) can be used.

### CROSS REFERENCE TO RELATED APPLICATIONS

This application claims benefit to European Patent Application No. EP 24175463.9,filed on May 13, 2024, which is hereby incorporated by reference herein.

### FIELD

The present disclosure relates to in-band wireless control of reconfigurable intelligence surfaces, and in particular to a method, system, data structure, computer program product and computer-readable medium for enabling a base station to send configuration commands and/or other communications wirelessly to the RIS.

### BACKGROUND

Reconfigurable intelligence surfaces (RIS) are artificially designed structures capable of transforming traditionally passive radio channels into programmable actuators, thereby enabling the creation of smart environments. The potential applications that RIS can achieve, such as coverage extension, localization, and security, have captivated numerous individuals and organizations in recent years, which has positioned RIS as one of key enablers for sixth-generation wireless cellular technology (6G).

However, while RIS-aided mobile networks can enhance wireless coverage, their integration has not been sufficiently studied. For example, fifth-generation wireless cellular technology (5G) offers base stations (BS) significant flexibility in scheduling radio resources for its end users. However, different users can require distinct RIS configurations to be effective and, consequently, the RIS state might have to be in tune with the BS's Media Access Control (MAC)/Physical (PHY) scheduling decisions. To achieve fast control, most existing RIS designs employ wired control interfaces (e.g., usually via universal serial bus (USB)). However, this approach has two important shortcomings: 1) a lack of third generation partnership project (3GPP) standardization, which complicates its integration with 3GPP-compliant MAC/PHY procedures at the BS; and 2) cabling costs, which might be prohibitive in outdoor settings-both of which impose wireless control as a requirement for practical RIS deployments.

Furthermore, state-of-the-art wireless RIS control solutions rely on out-of-band transceivers, such as visible light communication, modulated infrared signals, BLUETOOTH, Long Range (LoRa), or even WIFI. Yet, this approach encounters similar problems such as non-standard integration with 3GPP-compliant BSs, an uptick in RIS cost and energy consumption due to the need for a compatible active receiver, and/or they are ill-suited for long-range control in outdoor scenarios.

### SUMMARY

In an embodiment, the present disclosure provides a computer-implemented method for enabling a base station (BS) to provide configuration commands wirelessly to a reconfigurable intelligence surface (RIS). The method includes establishing a new codebook for each configuration from a previous set of configurations. The method further includes generating an RIS control message based on embedding amplitude-modulated (AM) signals into Orthogonal Frequency-Division Multiplexing (OFDM) signals using the new codebook and providing the RIS control message to the RIS to control the RIS. The method can be used to optimize and/or allow enhanced decision making for controlling the RIS using the BS. For instance, the method can synchronize its radio scheduler decisions and the optimization of the RIS configuration seamlessly and/or disguise RIS control messages into New Radio OFDM symbols in a way that the RIS can decode without active radio-frequency chains or other communication technologies. In some embodiments, machine learning (ML) and/or artificial intelligence (AI) techniques (e.g., a neural network (NN)) can be used.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 shows a table for 5G New Radio Numerology;

FIG. 2 illustrates a block diagram of a transmission chain of an OFDM signal;

FIG. 3 illustrates an environment including a base station and a plurality of RIS according to one or more embodiment of the present disclosure;

FIG. 4 shows an algorithm for a codebook generation according to one or more embodiment of the present disclosure;

FIG. 5 shows a polling method according to one or more embodiments of the present disclosure;

FIG. 6 shows a beacon method according to one or more embodiments of the present disclosure;

FIG. 7A shows a synchronization and clock correction aspect according to one or more embodiments of the present disclosure;

FIG. 7B shows another synchronization aspect according to one or more embodiments of the present disclosure;

FIG. 8 is a block diagram of an exemplary processing system, which can be configured to perform any and all operations disclosed herein.

### DETAILED DESCRIPTION

As mentioned above, while RIS-aided mobile networks can enhance wireless coverage, currently, their integration can include two important shortcomings: 1) a lack of 3GPP standardization; and 2) cabling costs. To address this, embodiments of the present disclosure include an RIS-aided mobile system that enables a seamless long-range, real-time, wireless RIS control, all while upholding the cost-effective, energy-conserving tenets of passive RIS technology and providing seamless integration with 3GPP-compliant MAC/PHY procedures.

In some instances, embodiments of the present disclosure include a system and/or method that enables radio base stations using Orthogonal Frequency-Division Multiplexing (OFDM)-based wireless interfaces to communicate amplitude-modulated signals without modifying its protocol stack and/or embedding these signals into its standard-compliant OFDM-based New Radio interface. Embodiments of the present disclosure can further include a protocol that minimizes wastage of radio resources. By utilizing the above, this can enable 5G base stations to control RIS via long-range wireless links, with seamless integration between the BS MAC layer and the associated RIS controller, and without requiring the RIS to integrate active radio-frequency chains to preserve its low-cost and negligible energy consumption.

In some instances, embodiments of the present disclosure can include a method that disguises RIS control messages into New Radio OFDM symbols in a way that the RIS can decode without active radio-frequency chains or other communication technologies. Additionally, and/or alternatively, embodiments of the present disclosure can further include a method such that BSs can synchronize its radio scheduler decisions and the optimization of the RIS configuration seamlessly, without third-party interfaces. By utilizing embodiments of the present disclosure, numerous advantages can be achieved including allowing the RIS to not require external communication technologies or active radio-frequency antennas, allowing the BS to not require external communication technologies (e.g., the BS can only include its 3GPP-compliant New Radio pipelines), and/or allowing the BS to jointly schedule radio resources and/or configure the RIS at the same time.

According to a first aspect, the present disclosure provides a computer-implemented machine learning method for enabling a base station (BS) to provide configuration commands wirelessly to a reconfigurable intelligence surface (RIS), comprising: establishing a new codebook for each configuration from a previous set of configurations; generating an RIS control message based on embedding amplitude-modulated (AM) signals into Orthogonal Frequency-Division Multiplexing (OFDM) signals using the new codebook; and providing the RIS control message to the RIS to control the RIS.

According to a second aspect, the method according to the first aspect further comprise that the BS is a fifth-generation wireless cellular (5G) BS and the RIS comprises an energy receiver, and wherein providing the RIS control message to the RIS comprises providing, by the 5G BS, the RIS control message to the energy receiver of the RIS.

According to a third aspect, the method according to any of the first or the second aspect further comprises that establishing the new codebook comprises: selecting a pulse based on a pulse width, a number of bits, and an OFDM symbol duration; and generating new configurations for the new codebook based on the selected pulse and the previous set of configurations.

According to a fourth aspect, the method according to any of the first to third aspects further comprises that generating the new configurations comprises: determining an On-Off Keying (OOK) signal for a first configuration from the previous set of configurations based on the selected pulse; determining new frequency-domain OFDM symbols based on the OOK signal for the first configuration; and storing the new frequency-domain OFDM symbols for the first configuration within the new codebook.

According to a fifth aspect, the method according to any of the first to fourth aspects further comprises that determining the new frequency-domain OFDM symbols comprises: sampling the OOK signal and performing a K-point Discrete Fourier Transform (DFT) to obtain a discrete representation of the OOK signal; and determining the new frequency-domain OFDM symbols based on performing a mean square error using the discrete representation of the OOK signal.

According to a sixth aspect, the method according to any of the first to fifth aspects further comprises that establishing the new codebook comprises: generating the new codebook based on the previous set of configurations; duplicating the new codebook; and prior to generating the RIS control message, providing the duplicated new codebook to the RIS.

According to a seventh aspect, the method according to any of the first to sixth aspects further comprises based on the RIS control message, decoding, by the RIS, information associated with the RIS control message to obtain a bit sequence; converting, by the RIS, the bit sequence into a unique identifier; and loading, by the RIS, phase shift configurations into phase shifters of the RIS based on the unique identifier and the new codebook.

According to an eighth aspect, the method according to any of the first to seventh aspects further comprises determining a pre-agreed time interval to provide the RIS control message, and wherein providing the RIS control message to the RIS to control the RIS is based on the pre-agreed time interval.

According to a ninth aspect, the method according to any of the first through eighth aspects further comprises that providing the RIS control message to the RIS to control the RIS is based on using a beacon signal to minimize a time duration that a multi-antenna receiver of the RIS devotes to obtaining the RIS control message.

According to a tenth aspect, the method according to any of the first through ninth aspects further comprises that the time duration is associated with units of OFDM symbol periods, and wherein providing the RIS control message to the RIS to control the RIS comprises: dividing the time duration into pre-determined and fixed beacon periods; providing the beacon signal at a next beacon period indicated by the pre-determined and fixed beacon periods; and providing the RIS control message to the RIS at an additional symbol period that is subsequent to the next beacon period.

According to an eleventh aspect, the method according to any of the first through tenth aspects further comprises generating the beacon signal using a Golay sequence and a generation algorithm, wherein the beacon signal is detectable by the multi-antenna receiver of the RIS with a number of antenna elements that is below a pre-determined threshold, wherein the pre-determined threshold is associated with a signal-to-noise ratio (SNR).

According to a twelfth aspect, the method according to any of the first through eleventh aspects further comprises that the RIS comprises a plurality of antenna elements, and wherein the method further comprises: activating, by the RIS, a pre-determined subset of the plurality of antenna elements for one symbol every beacon period; based on detecting a beacon signal provided by the BS during the one symbol, activating, by the RIS, remaining antenna elements from the plurality of antenna elements during an additional symbol, and wherein the BS provides the RIS control message to the RIS during the additional symbol.

According to a thirteenth aspect, the method according to any of the first through twelfth aspects further comprises that one or more symbols are between the one symbol for detecting the beacon signal and the additional symbol for the RIS control message.

According to a fourteenth aspect, a computer system is provided for enabling a base station (BS) to provide configuration commands wirelessly to a reconfigurable intelligence surface (RIS). The computer system comprises one or more hardware processors, which, alone or in combination, are configured to provide for execution of the method according to any of the first to thirteenth aspects.

A fifteenth aspect of the present disclosure provides a tangible, non-transitory computer-readable medium having instructions thereon, which, upon being executed by one or more processors, provides for execution of the method according to any of the first to the thirteenth aspects.

Prior to describing embodiments of the present disclosure, additional background information (e.g., background information for RIS, 5G New Radios, and passive RIS control receivers) is first described. For instance, an RIS is, sensu lato, a planar structure populated with a large number of small, controllable, passive reflecting cells that can adjust their electromagnetic response. By collectively tuning these elements, a RIS can programmatically alter the propagation behavior of impinging radio waves (e.g., to perform passive beamforming on reflected signals).

The advantages of RIS over active alternatives, such as pico-cells, relays or the so-called active RIS, are significant. Firstly, because its cells only passively reflect signals, they do not require radio-frequency (RF) chains and, as a result, incur vastly reduced hardware and energy costs, which allows for off-the-electricity-grid deployments and massive outdoor structures. Secondly, since RIS do not perform active signal processing, they natively support full-duplex operation. Thirdly, the absence of complex electronic gear renders RIS lightweight and geometrically flexible, facilitating simpler and cheaper deployment and maintenance.

RIS can be designed on a printed circuit board (PCB) using metamaterial or patch antennas with different mechanisms. Varactor diodes and liquid crystals offer continuous-range electromagnetic responses but can introduce non-linearities (the former) and are temperature-sensitive and low-responsive (the latter). Conversely, Positive-Intrinsic-Negative (PIN) diodes and RF switches are more cost-efficient and energy-efficient and can provide fast 3-bit configurations, which is a good resolution for most of the use cases.

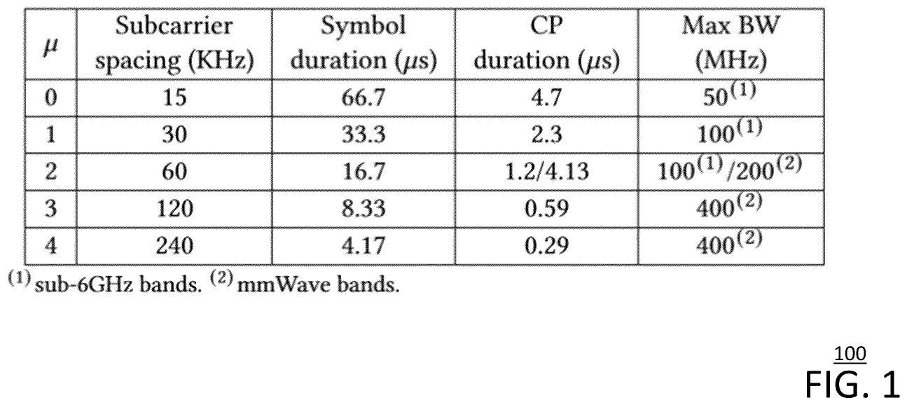

The below describes the 5G New Radio. For example, New Radio (NR), which is 5G′s PHY/MAC interface, uses OFDM with cyclic prefix (CP) with a flexible numerology μ. The basic spectrum unit is the resource block (RB), which encompasses twelve subcarriers with 15·24 kilohertz (KHz) spacing. Time is divided into 1 millisecond (ms) subframes, each carrying 2^{μ} slots with, usually, 14 OFDM symbols lasting 66.7·2^{-μ} microseconds (μs). Examples of the flexible numerology μ are depicted in FIG. 1.

For instance, FIG. 1 shows a table 100 for 5G New Radio Numerology. For instance, the table 100 shows the examples of the flexible numerology μ and their subcarrier spacing, symbol duration, CP duration, and maximum bandwidth (BW). The subcarrier spacing can be in kilohertz (KHz), the symbol duration can be in microseconds (μs), the CP duration can also be in microseconds (μs), and the maximum BW can be in megahertz (MHz). Furthermore, the maximum BW can indicate sub-6 gigahertz (GHz) bands and/or millimeter (mm) wave bands.

For every Transmission Time Interval (TTI), often one slot, the BS's MAC schedules one Transport Block (TB) for/from every active User Equipment (UE), which are signaled to UEs by grants. The TB size (e.g., bit size) depends on the numerology, the amount of buffered data, the RB scheduling policy of the distributed unit (DU), and the modulation and coding scheme (MCS), which can be selected based on the signal-to-noise ratio (SNR).

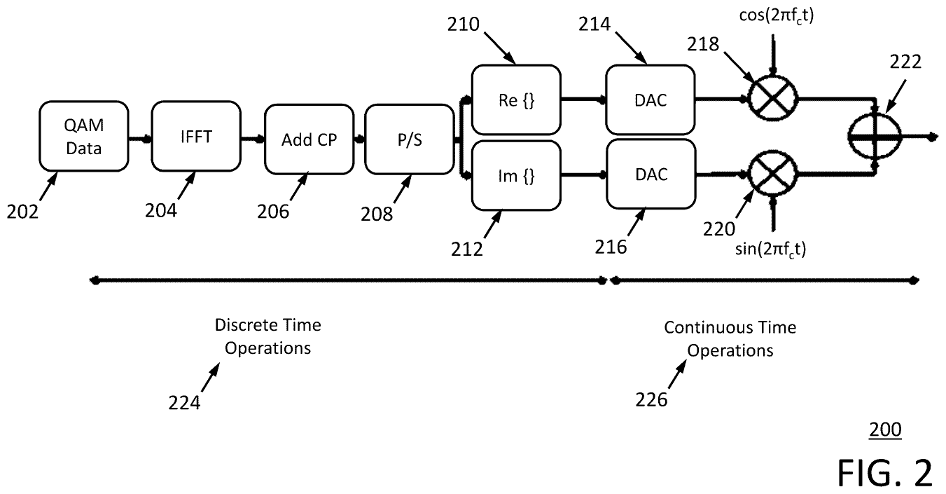

FIG. 2 illustrates a block diagram 200 of a transmission chain of an OFDM signal. For instance, an OFDM signal is composed of N sinusoids, also known as bins, with a spacing denoted as fₖ. These sinusoids are modulated by data symbols that have a duration of Tₛ, which is equal to the reciprocal of the subcarrier spacing. In the context of an OFDM transmission, a complex data symbol block S=[S₀, S₁, . . . , S_{N-1}]^{T} is used. Each element Sₖ represents a quadrature amplitude modulated (QAM) symbol, where sₖ=aₖ+jbₖ, with aₖ and bₖ being the real and imaginary parts of the symbol, respectively. This data symbol block S is then fed into an N-point Inverse Fast Fourier Transform (IFFT) operation, resulting in discrete time-domain samples represented as:

$$x [ k ] = {\sum }_{k = 0}^{K - 1} {s}_{k} \cdot {e}^{j \cdot \frac{2 π}{N} \cdot m \cdot k} , k = 0 , 1 , … , N - 1 .$$

In other words, the QAM data 202 can include the complex data symbol block S with both real and imaginary parts. The data symbol block can be fed into an IFFT block 204 that performs an IFFT operation to obtain discrete time-domain samples.

The samples to be transmitted are passed through an Add CP block 206 and a parallel-to-serial (P/S) converter 208. For example, a CP of duration T_{cp} can be inserted into the discrete time-domain samples, e.g., the last L samples in x are copied and placed as the first L samples in u, as follows:

$$u = [ x [ N - L - 1 ] , … , x [ N - 1 ] , … , x [ 0 ] , … , x [ N - 1 ] . ]$$

The baseband samples with the cyclic prefix are then divided into in-phase and quadrature components and are fed to the digital-to-analog converter (DAC) to generate continuous-time waveforms s_{I}(t) and s_{Q}(t), respectively. Finally, these waveforms are up-converted to the carrier radio frequency (RF) and added to generate the passband signal denoted as Equation (Eq.) (1) below:

$$s ( t ) = Re \{ s ( t ) {e}^{j \cdot 2 π \cdot {f}_{rc} \cdot t} \} = {s}_{I} ( t ) cos ( 2 π \cdot {f}_{rc} \cdot t ) + {s}_{Q} ( t ) sin ( 2 π \cdot {f}_{rc} \cdot t ) \qquad Eq . ( 1 )$$

where f_{rc} is the frequency used by the base station.

In other words, the output from the Add CP block 206 can include the baseband samples with the CP, and then are divided by the P/S block 208 into in-phase and quadrature components. The in-phase components are provided to real (Re { }) block 210 and the quadrature components are provided to the imaginary (Im { }) block 212, and then the results of from blocks 210 and 212 are provided to the DAC blocks 214 and 216 to generate continuous-time waveforms s_{I}(t) and s_{Q}(t). Subsequently, these waveforms are up-converted to the carrier RF using the multipliers 218 and 220. For instance, the multiplier 218 can mix the continuous-time waveforms S_{I}(t) with the cos (2πf_{c}t) and the multiplier 220 can mix the continuous-time waveforms s_{Q}(t) with the sin (2πf_{c}t). Afterwards, an addition 222 can be performed to add the results from the multipliers 218 and 220 to obtain the passband signal, which is shown above. Thus, the block diagram 200 shows both the discrete time operations 224 and the continuous time operations 226 (e.g., based on using the DAC blocks 214 and 216).

The passive RIS control receiver is now described. For example, embodiments of the present disclosure can rely on the ability of a RIS to decode wireless control messages without requiring additional Radio Frequency (RF) chains dedicated to this task. This can be achieved, for instance, with the approach described in WO 2024/027945 A1 (“Rossanese”), titled RECONFIGURABLE INTELLIGENCE SURFACE, RIS, WITH SENSING CAPABILITIES AND METHOD FOR OPERATING THE SAME, which was filed on Oct. 20, 2022 and the entirety of which is hereby incorporated by reference herein. For instance, Rossanese extends the baseline RIS design introduced in a previous work (see e.g., Marco Rossanese, Placido Mursia, Andres Garcia-Saavedra, Vincenzo Sciancalepore, Arash Asadi, and Xavier Costa-Perez. 2022. Designing, building, and characterizing RF switch-based reconfigurable intelligent surfaces. In Proceedings of the 16th ACM Workshop on Wireless Network Testbeds, Experimental evaluation & CHaracterization (WINTECH '22). Association for Computing Machinery, New York, NY, USA, 69-76, which is incorporated by reference herein). For instance, Rossanese provides a first innovation over the previous work by integrating a low-cost, energy-inexpensive power sensor that can decode simple signals, such as amplitude-modulated (AM) signals, with simple operations. Furthermore, Rossanese uses a network of microstrip lines and hybrid couplers that merge and route RF signals from individual RIS cells to maximize power at the power sensor. In this way, the antennas of the RIS can be in sensing mode (redirecting impinging signals to the power sensor that can be used to decode simple signals) or in reflection mode (towards users with configured phase shifts).

Turning now to the goals mentioned above, which face the two unresolved challenges (e.g., a lack of 3GPP standardization and/or cabling costs), embodiments of the present disclosure can include two features: 1) a first feature for a long-range in-band control transmitter; and 2) a second feature for an RIS control protocol. The first feature will be described initially and then the second feature will be described.

The first challenge is to empower an OFDM-based base station such as 5G′s to emit RIS control messages in-band, using the BS's own OFDM-based wireless interface. This has two advantages: 1) Seamless integration of wireless RIS control into 3GPP-compliant 5G BSs; and 2) Long-range wireless RIS control as embodiments of the present disclosure can rely on NR's power, which is usually larger than WIFI, BLUETOOTH, and/or infrared alternatives.

To address this challenge, embodiments of the present disclosure describe a scheme that embeds amplitude-modulated (AM) RIS control commands, decodable by the RIS power sensor, directly into standard OFDM-modulated, 5G NR data channels. This technique allows a 5G BS to exert wireless control over a RIS without major modifications to its standard data processing architecture.

To this end, embodiments of the present disclosure can include the goal of converting the payload transported by OFDM symbols into amplitude-modulated (AM) signals. At a conceptual level, the OFDM-based BS within the configuration of embodiments of the present disclosure can manipulate the amplitude characteristics of OFDM symbols to generate an AM signal. In some examples, this modulation process can be accomplished by appropriately configuring the data bits within each subcarrier of the OFDM symbol, obviating the necessity for hardware-based power control mechanisms.

Within the context of AM modulation, the amplitude of a sinusoidal carrier signal varies in accordance with the instantaneous values of a message signal, which serves as the modulating signal. The mathematical representation of an amplitude-modulated signal a_{AM}(t) is expressed as Equation (Eq.) 2 below:

$$\begin{matrix}{a}_{AM} ( t ) = {A}_{c} \cdot [ 1 + ψ ( t ) ] \cdot cos ( 2 π {f}_{rc} t ) \\ = {A}_{c} \cdot [ cos ( 2 π {f}_{rc} t ) + ψ ( t ) \cdot cos ( 2 π {f}_{rc} t ) ] \\ = {A}_{c} \cdot [ ψ ( t ) \cdot cos ( 2 π {f}_{rc} t ) + sin ( 2 π {f}_{rc} t + 90 ° ) ] .\end{matrix} \qquad Eq . ( 2 )$$

Here, a_{AM}(t) represents the baseband signal, and A_{c} denotes the amplitude of the carrier signal. Comparing Eq. 1 and Eq. 2, it becomes evident that the manipulation of the baseband OFDM signal is the essential requirement for achieving the goal above, e.g., s_{I}(t)≅ψ(t). Furthermore, the quadrature component (e.g., s_{Q}(t)) has no role, so it can be chosen to be any value as it only adds to the direct current (DC) component of the signal.

In this context, the selection of the modulation scheme a_{AM}(t) is crucial to ensure that decoding at the RIS, which lacks a baseband processing unit, is straightforward. In some embodiments, when prioritizing energy efficiency at the receiver, On-Off Keying (OOK) modulation emerges as an optimal choice. OOK modulation allows for non-coherent demodulation, which can mean it does not require strict phase coherence, and it places minimal demands on gain control and resolution within the receiver. As a result, OOK modulation can be adopted for the transmission of the configuration information of the RIS.

Mathematically, an OOK signal can be expressed as follows:

$$ψ ( t ) = {\sum }_{m = 0}^{M - 1} {b}_{m} \cdot p ( t - {mT}_{p} ) .$$

In this equation, bₘ represents the signal amplitude, which takes values of either 1 or −1 for OOK modulation. p(t) characterizes the shape of the transmitted pulse, Tₚ is the pulse width, and M denotes the total number of bits. The discrete representation of the OOK signal can be formulated as Equation (Eq.) 3 below:

$$ψ [ k ] = ψ ( t ) {\vert}_{t = {kT}_{s}} , - ∞ < k < ∞ , \qquad Eq . ( 3 )$$

where Tₛ coincides with the sampling frequency of OFDM system, ensuring that the number of discrete samples matches that of the OFDM baseband signal in Eq. 1.

Thus, to generate the AM signal from OFDM, embodiments of the present disclosure can determine (e.g., find) the optimal frequency-domain OFDM symbols. This can be achieved by minimizing the mean square error between Eq. 1 and Eq. 3, e.g.,

$$\begin{matrix}{min}_{{s}_{k}} & {‖ ψ [ k ] - x [ k ] ‖}_{2}^{2} \\ s . t . & {s}_{k} ∈ F , ∀ k ∈ \{ 1 , … , N \} .\end{matrix}$$

The above least-squares problem can be solved optimally to minimize the disparity between the OFDM waveform and the target OOK waveform. For instance, the above expression can be used to minimize the difference between the OFDM x[k] and the target OOK waveforms ψ[k] using a least-squares approach.

The RIS Controller (RISC) in the RIS assumes a pivotal role in the orchestration of various configurations onto the RIS. Its primary responsibilities encompass the storage and maintenance of a lookup table, which houses a predefined set of configurations denoted as C, with the cardinality of C denoted as C. Additionally, an identical copy of this lookup table is retained within the BS. This duplication empowers the BS to emit control signals instructing the RISC to load a specific configuration from the set C. Thus, set C serves as the canonical codebook of configurations, acting as a reference point for both the RISC and the BS. This codebook streamlines RIS configuration management processes. In an embodiment, each entry in the codebook can be uniquely identified by a 7-bit index.

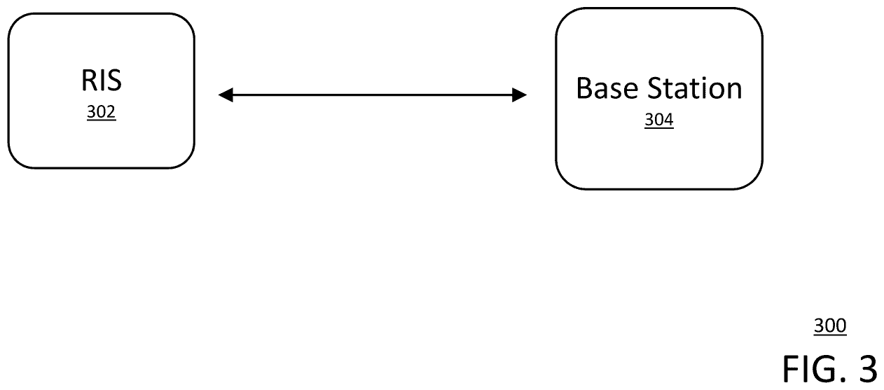

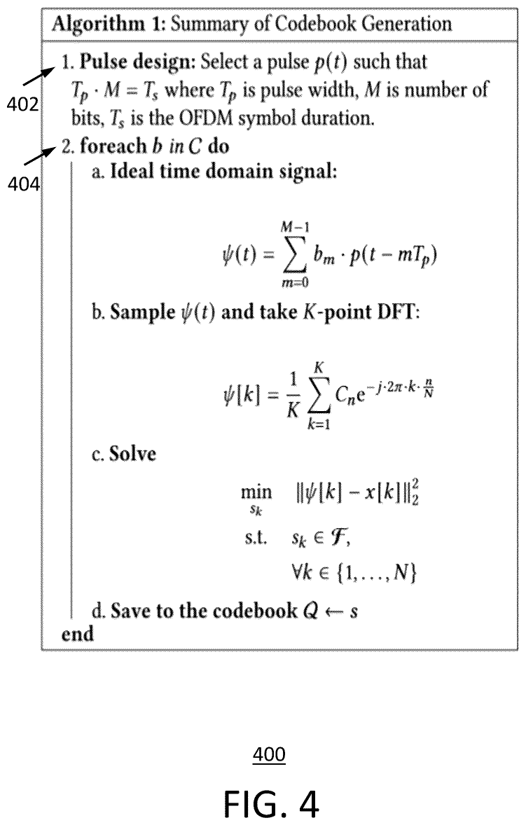

As such, embodiments of the present disclosure can have a main goal of having the BS re-configure the RIS to maximize network performance in tune with the scheduling choices of the BS. Hence, the BS is responsible for transmitting the appropriate codebook index to the RIS, allowing the RIS to retrieve the corresponding configuration from the codebook for practical use. Given that the codebook entries and their associated identifiers are pre-determined, it is advantageous to establish a codebook Q of sub-carrier entries for each configuration. These codebook entries include complex constellation symbols and are loaded during the signaling phase to encode the configuration bits on the envelope of the signal. The specific procedure for this process is outlined in the Algorithm shown in FIG. 4 and will be described after FIG. 3, which shows an environment including RIS and base station.

For example, FIG. 3 illustrates an environment 300 including a base station (BS) 304 and a plurality of RIS 302 according to one or more embodiment of the present disclosure. The plurality of RIS 302 can be distributed within a grid and/or a 2D distribution. As mentioned above, a BS 304 can be in communication (e.g., wireless communication) with a plurality of RIS 302. The BS 304 and the plurality of RIS 302 can include memory that stores a canonical codebook of a set of configurations C. To perform one or more of the aspects described above, embodiments of the present disclosure can reconfigure the RIS 302 to maximize network performance in tune with the scheduling choices of the BS. Thus, embodiments of the present disclosure can embed AM RIS control commands, which are decodable by the power sensor of the RIS 302, directly into the standard OFDM-modulated, 5G NR data channels.

For example, initially, the BS 304 can establish a new codebook Q of sub-carrier entries for each configuration using Algorithm 1, which is shown in FIG. 4. FIG. 4 shows an algorithm 400 for a codebook generation according to one or more embodiment of the present disclosure. For instance, the algorithm 400 can be a summary algorithm for the codebook generation and can include two steps—a pulse design step 402 and a “for” loop step 404. The “for” loop step 404 can include four sub-steps—an ideal time domain step, a sample step, a solve step, and a save to the new codebook step.

For instance, at the pulse design step 402, the BS 304 can select a pulse p(t) such that Tₚ·M=Tₛ, where Tₚ is the pulse width, M is the number of bits, and Tₛ is the OFDM symbol duration. For instance, as mentioned above, to prioritize energy efficiency at the receivers of the RIS 302, OOK modulation can be utilized, which can allow for non-coherent demodulation and places minimal demands on gain control and resolution within the receivers. The OOK signal is described above and includes a pulse p(t), which can characterize and/or indicate a shape of the transmitted pulse. At step 402, the BS 304 can select this pulse p(t) such that the dot product of the pulse width Tₚ and the total number of bits M is equal to the time duration Tₛ, which is the OFDM symbol duration.

After selecting the pulse p(t), the BS 304 can perform step 404. For example, for each b in C (e.g., each configuration from the set of configurations C), four sub-steps are performed. In the first sub-step, an ideal time domain signal is obtained. For instance, after selecting the pulse p(t), the BS 304 can determine the OOK signal ψ(t) for each configuration from the set of configurations C. This can be represented below, which is also shown above:

$$ψ ( t ) = {\sum }_{m = 0}^{M - 1} {b}_{m} \cdot p ( t - {mT}_{p} ) .$$

At a second sub-step, the BS 304 can sample the OOK signal ψ(t) that was determined by at the first sub-step and a K-point Discrete Fourier Transform (DFT) can be taken. For instance, the BS 304 can obtain the discrete representation of the OOK signal based on performing sampling and taking the K-point Discrete Fourier Transform (DFT). This can be represented below:

$$ψ [ k ] = \frac{1}{K} {\sum }_{k = 1}^{K} {C}_{n} {e}^{- j \cdot 2 π \cdot k \frac{n}{N}}$$

For instance, ψ(t) is in the time domain discretized with N points, where n is the time sample index. ψ[k] is the discrete representation in the frequency domain. The expression above is the usual DFT where K is the number of points for the Discrete Fourier Transform and k is the frequency index. Cₙ is the nth sample of the time domain ψ(t). This step can be used to ensure that the OOK is compatible with the OFDM symbols prior to optimization.

Following, at a third sub-step, the BS 304 can perform a solving step. For example, to generate the AM signal from the OFDM, the BS 304 can determine the optimal frequency-domain OFDM symbols. For instance, in an embodiment, the BS can determine the optimal (e.g., new) frequency-domain OFDM symbols based on minimizing the mean square error between Eq. 1 and Eq. 3 above, which can minimize the disparity between the OFDM waveform and the target OOK waveform. This is shown by the expression below:

$$\begin{matrix}{min}_{{s}_{k}} & {‖ ψ [ k ] - x [ k ] ‖}_{2}^{2} \\ s . t . & {s}_{k} ∈ F , ∀ k ∈ \{ 1 , … , N \} .\end{matrix}$$

At a fourth sub-step, the BS 304 can save (e.g., store) the determined optimal frequency-domain OFDM symbols s to the codebook Q. Following, step 404 (e.g., the “for” loop) can repeat for the other configurations from the set of configurations C.

As such, based on performing algorithm 400, the BS 304 can generate (e.g., establish) a new codebook Q of sub-carrier entries for each configuration from the previous set of configurations C. Subsequently, after performing algorithm 400, the BS 304 can duplicate the new codebook Q and provide the duplicated new codebook Q to the RIS 302. The RIS 302 can include an RIS controller (RISC), which assumes a pivotal role in the orchestration of various configurations onto the RIS. During operation, the BS 304 can utilize its version of the new codebook Q to transmit an AM RIS control command (e.g., RIS control messages in-band) to the RIS 302. The RISC of the RIS 302 can utilize its version of the new codebook Q that was provided previously by the BS 304 to decode the AM RIS control command.

For example, the RIS 302 (e.g., the receiver of the control messages from the BS 304) can use an analog signal envelope detector, an analog-to-digital (ADC) that samples the signal at the carrier frequency followed by a matched filter to maximize the signal-to-noise ratio (SNR) of the pulse shape. The matched filter output is then fed to a decision block, programmed into the RIS microcontroller (e.g., the RISC), which determines the transmitted bit sequence. Once the bit sequence is decoded and converted to a unique identifier, the corresponding phase shift configuration from a known codebook (e.g., from the new codebook Q) is loaded into the phase shifters. In other words, the RIS 302 can include an analog signal envelope detector to detect the signal from the BS 302. Subsequently, the RIS 302 can include an ADC that samples the signal at the carrier frequency and a matched filter that maximizes the SNR of the pulse shape. The output from the matched filter can be fed to the RISC, which determines the transmitted bit sequence based on decoding the output. Then, the decoded bit sequence is converted to a unique identifier and the corresponding phase shift configuration is loaded into the phase shifters.

The second feature for the RIS control protocol is now described. For example, the above in-band wireless control mechanism creates an overhead on data communication, as RIS control messages consume one symbol along the whole bandwidth of the BS that cannot be used to transmit data. Therefore, to make the aforementioned system effective, embodiments of the present disclosure can tackle a remaining challenge to design a BS-to-RIS control protocol that minimizes overhead (OFDM symbols used for RIS control instead of standard data delivery) yet maximizes RIS control reliability (minimizes losses and bit-error rate of RIS control messages).

The lack of strict time synchronization between the RIS and the BS makes achieving this goal particularly challenging. To address this, embodiments of the present disclosure include a protocol that achieves soft synchronization and exploits three RIS operating modes: (i) a full reflection mode, with all the RIS cells configured to maximize end-user performance; (ii) a full sensing mode, with all the cells configured to maximize RIS control channel reliability; and (iii) a hybrid mode, with a subset of RIS cells in sensing mode and the complementary in reflection mode, used to achieve soft synchronization and schedule RIS control messages to minimize overhead.

As such, two control signal protocols (e.g., methods) that utilize the in-band signaling technique are described below, which can be used to minimize the time that a multi-antenna receiver of the RIS 302 has to devote to capture signals. In the first control signal protocol, embodiments of the present disclosure can utilize a polling method.

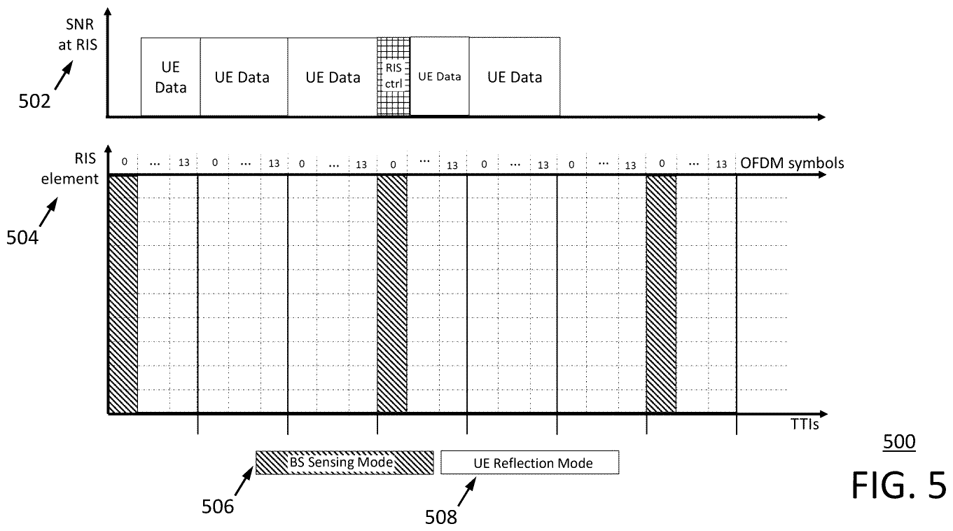

For example, FIG. 5 shows a polling method 500 according to one or more embodiment of the present disclosure. In this approach, the BS 304 periodically sends RIS control messages at pre-agreed intervals. To receive the control messages, the RIS 302 configures all its antenna elements to sensing mode to decode the control message with the highest possible reliability. In the example depicted in FIG. 5, the control interval is nine symbols.

For instance, FIG. 5 shows two graphical representations-a graphical representation 502 for the SNR at the RIS and a graphical representation 504 for the RIS element. For instance, the graphical representation 502 includes time slots for user equipment (UE) data and a single time slot for the RIS control (e.g., to receive the control messages). In other words, the BS 304 and the RIS 302 can determine a period (denoted by the RIS control time slot) to provide the RIS control messages, such as the RIS control messages that are described above in the first feature. As such, the BS 304 and the RIS 302 can determine a pre-agreed interval (e.g., every nine OFDM symbols) for the BS 304 to provide the RIS control messages, and the RIS 302 can be ready to receive these RIS control messages at the specified interval.

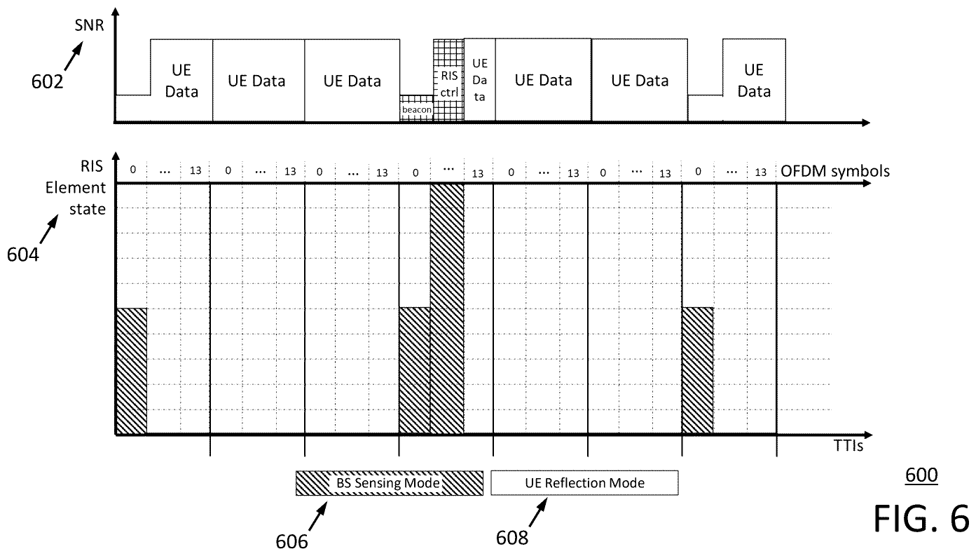

The graphical representation 504 can indicate the RIS element (e.g., the RIS element state). For instance, the RIS 302 can be operated in a full reflection mode 508 where all the RIS cells are configured to maximize end-user performance and a full sensing mode 506 where all for the cells are configured to maximize RIS control channel reliability. The graphical representation 504 can show the operation of the RIS 302 within those two modes at different Transmission Time Intervals (TTIs). As such, the RIS 302 spends most of the time in the full reflection mode 508. When the RIS 302 is in the full reflection mode 508, 100% of the unit elements can be reflecting the incoming power from the BS 304, providing the best performance for the communication system. When in this state, the RIS 302 can be unable to sense beacons or control messages from the BS 304. If desired to reconfigure the RIS 302, one possible approach can be to set the RIS 302 into the full sensing mode 506 (100% of unit elements in reception) with a fixed time interval, such that it can listen for a control message from the BS 304 and in case of reception, reconfigure. In some examples, this might not be as efficient because it can completely stop the communications for the duration of one symbol (e.g., 72 microseconds (μs)). This might mean wasting resources and therefore, a more efficient approach can be to involve warning beacons, which is described in FIG. 6.

In the second control signal protocol, embodiments of the present disclosure can utilize a beacon method. In this method, the BS 304 generates a periodic beacon that announces the arrival of a RIS control message. This beacon is a signal that is particularly designed to be easy to detect with small power. In this way, only a portion of RIS elements can be used to detect the presence of a beacon, leaving the remaining elements in reflection mode, which avoids wasting the symbol when RIS re-configurations are not required. As such, the beacon signal can be used to minimize a time duration that a multi-antenna receiver of the RIS devotes to obtaining the RIS control message.

This is illustrated in FIG. 6 for a beacon interval set to 9 symbols. For example, FIG. 6 shows a beacon method 600 according to one or more embodiment of the present disclosure. For instance, similar to FIG. 5, FIG. 6 shows two graphical representations-a graphical representation 602 for the SNR at the RIS and a graphical representation 604 for the RIS element. For instance, the graphical representation 602 includes time slots for user equipment (UE) data, a beacon time slot, and a time slot for the RIS control (e.g., to receive the control messages). In other words, the BS 304 can provide a beacon signal prior to providing the RIS control message. At the beacon time slot, the RIS 302 can operate in a hybrid mode (e.g., with a subset of RIS cells in sensing mode and another subset in reflection mode), which avoids wasting the symbol when RIS re-configurations are not required. When obtaining the beacon signal, the RIS 302 can be ready to receive the RIS control message at a subsequent time slot. The subsequent time slot might not be limited to the next time slot. For instance, a configuration parameter can be set at the beginning and agreed between the RIS 302 and the BS 304. This configuration parameter can indicate the next time slot (e.g., the immediate time slot after sending the beacon signal) or “X” time slots in the future where “X” can be any time slot in the future.

The graphical representation 604 can indicate the RIS element state. For instance, the RIS 302 can be operated in a reflection mode 608 where all the RIS cells are configured to maximize end-user performance and a sensing mode 606 where all for the cells are configured to maximize RIS control channel reliability. In addition, at the beacon time slot, the RIS 302 can be operated in a hybrid mode that includes operating a first set of unit elements of the RIS 302 in the sensing mode 606 and operating a second set of unit elements in the reflection mode 608. The hybrid mode might not include and/or be a half reflection mode 608 and half sensing mode 606. Instead, a percentage a of unit elements can be selected and placed in the sensing mode 606. The choice of the percentage a can depend on the system characteristics (e.g., elements of the RIS 302, the gain and power of the BS 304, the path loss, and so on). As shown, in the first beacon signal time slot, no beacon signal was detected and therefore, in the immediate following time slot, the RIS 302 still operates normally. However, in the, second beacon signal time slot, a beacon signal was detected and thus, the RIS 302 operates differently than during the first beacon signal time slot.

In other words, a time duration can be measured in units of OFDM symbol periods. For each OFDM symbol period (e.g., the 9 symbol period shown in FIG. 6), a pre-determined and fixed beacon period can be determined. As such, the entire time duration can be divided into the pre-determined and fixed beacon periods. When the BS 304 seeks to communicate data to the receiver of the RIS 302, it can wait until the next beacon opportunity (e.g., the next or upcoming pre-determined and fixed beacon period), and can announce its intention using a beacon signal. The beacon signal can be any suitable predefined AM waveform such as, but not limited to, a special Golay sequence and/or Algorithm 1 described in FIG. 4. Additionally, and/or alternatively, a neural network (NN) can be used for the beacon detection, which is described below. This special and fixed beacon signal can be easily detected with low signal-to-noise-ratio (e.g., by a receiver of the RIS 302 with a small number of low-cost antenna elements) as regular data may require higher signal-to-noise ratio (e.g., the receiver may need all the antenna elements active to receive regular data). As such, at each pre-determined and fixed beacon periods, the receiver of the RIS 302 can activate a pre-determined subset of antenna elements for one symbol every beacon period (e.g., five of the ten antenna elements shown in FIG. 6). If the receiver detects a beacon signal, it activates the remaining antenna elements (e.g., the remaining five antenna elements) for an additional symbol (e.g., denoted by all ten antenna elements operating in a different mode). In some instances, an interval can be included between the beacon signal and the data exchange (e.g., the exchange of the RIS control message). After the symbol selected to exchange the data, the receiver can deactivate all of its antenna elements until the next beacon period.

For instance, for every beacon interval, a portion of the RIS elements is configured to sensing mode 606. In this example, a beacon preceding a control message is only sent in the second interval out of three intervals depicted in the illustration of FIG. 6. As shown in FIG. 6, during the first and third beacon intervals, the RIS 302 can still relay UE data at a smaller cost of some SNR degradation. SNR degradation occurs during beacon intervals because the RIS cannot use all the antenna elements for reflection. The actual among of SNR lost depends on the distance between UEs and the RIS.

In some instances, embodiments of the present disclosure can use one OFDM symbol to transmit a pre-defined synchronization word as the beacon signal. Because the above protocol employs a subset of antenna elements to maximize the power of the beacon signal, it is important to design a signal that is easily detectable. More specifically, this signal can include custom Golay sequences that are concatenated to form a unique word of length 24 bits. These bits can be modulated as described in algorithm 400 (e.g., Algorithm 1) above.

Since the signal is fixed and known a priori, the simplest method to detect the presence of a signal is by energy detection. The receiver accumulates the amplitude of N consecutive incoming signal samples that are fed into a correlator, which produces a measure:

$$z [ n ] = {\sum }_{k = - ∞}^{∞} h [ n - k ] y [ k ]$$

where y[k] is the received signal and h[k] is the matched filter input. If the magnitude of z[n] exceeds a threshold γ, it is assumed that an incoming beacon has been detected. The selection of threshold γ is a design criterion as it imposes a trade-off between the rate of false positives and missed detections. The output of the matched filter produces a peak when the known beacon signal is perfectly matched to the incoming signal.

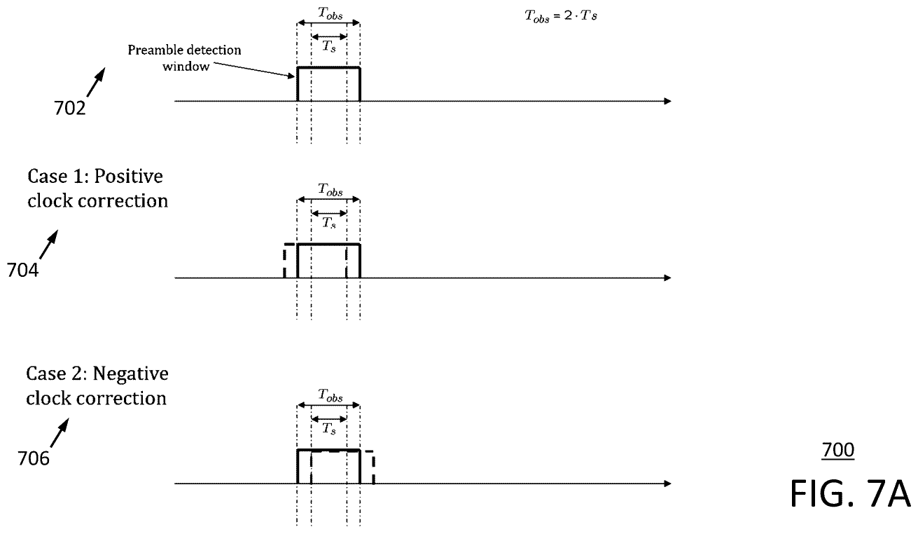

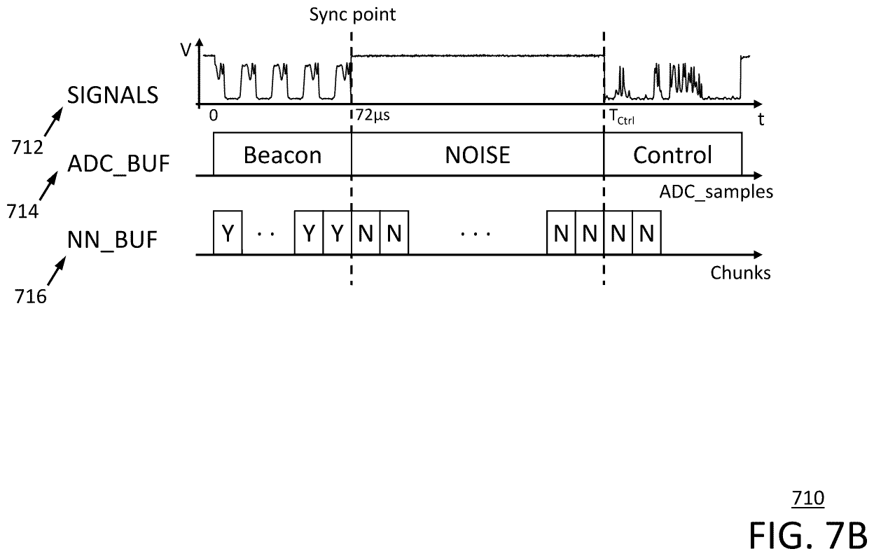

In other instances, embodiments of the present disclosure can use the same beacon signal to achieve rough time synchronization between BS 304 and RIS 302. The RIS 302 utilizes the internal clock of an onboard microcontroller to maintain synchronization and facilitate transitions between various operational modes at predetermined intervals. However, the inherent drift in the microcontroller's clock can necessitate periodic estimation and subsequent correction. This estimation and correction process occurs upon the detection of a beacon. To this end, the RIS microcontroller maintains a timer that resets upon the detection of a beacon. When the timer expires, the RIS protocol entails a transition to partial absorption mode for beacon sensing purposes. The system remains in this mode for a duration denoted as T_{obs}, which equals twice the symbol time Tₛ, as depicted in FIG. 7A. Owing to clock drift, the initiation of this observation period can occur prematurely or belatedly relative to the intended timing. Hence, corrective measures are imperative to achieve precise synchronization for the transmission of control messages. If the magnitude of z[n] exceds a threshold γ during which it is assumed that there is an incoming beacon starting at the point where z[n] exceeds that threshold. This information is then used to reset a timer for the next beacon interval.

In other words, FIG. 7A shows a synchronization and clock correction aspect 700 according to one or more embodiment of the present disclosure. For example, the aspect 700 includes representations 702-706. Representation 702 shows the preamble detection window as well as that the duration T_{obs} is equal to twice the symbol time Tₛ. Representation 704 shows a first case for positive clock correction and representation 706 shows a second case for negative clock correction.

FIG. 7B shows another synchronization aspect 710 according to one or more embodiment of the present disclosure. For example, once a beacon is detected, the RIS 302 can be prepared to receive a RIS control message in a time T_{ctrl}. This requires time synchronization, as the micro controller unit (MCU) of the RIS 302 can be required to initiate a countdown from the end of the beacon. Measuring noise after a beacon detection indicates the beacon time boundary (and thus a 5G OFDM symbol boundary), which is used to correct the MCU's internal clock drift. The outputs of the neural network (NN) employed for beacon detection are stored in a binary buffer to record beacon occurrences. The MCU periodically analyzes the noise level within the analog to digital converter (ADC) buffer to identify discontinuities, indicative of a signal of interest. Upon detecting a discontinuity, the MCU records the corresponding buffer index. This index enables the system to query the NN buffer, distinguishing between signals originating from beacon/control messages and other sources (e.g., 5G user data), and facilitates time synchronization. Given that each sample in the ADC buffer represents a fixed time interval, the precise timing of the detected signal is determined by its buffer position. This synchronization point is used to predict the arrival of the next control message as the timings are known and to compensate for clock drifts relative to the base station clock, ensuring system-wide timing accuracy. This is shown by the representations 712-716. For instance, representation 712 shows the signals (e.g., Voltage (V)) over a period of time t. The representation 714 shows the ADC buffer that includes the beacon, noise, and the control. The representation 716 shows the NN buffer (e.g., the binary buffer of outputs from the NN) that includes Yes (Y) and No (N).

In an embodiment, the present disclosure provides a first method (e.g., a first step) to embed amplitude-modulated (AM) signals into OFDM signals, which is described in Algorithm 1 of FIG. 4. This enables, e.g., a 5G BS (e.g., the BS 304) to communicate with simple low-energy receivers that cannot afford complex baseband operations. In an embodiment, the present disclosure provides a second method (e.g., a second step) to communicate data using the first method while minimizing the time that a multi-antenna receiver has to devote to capture signals. This method comprises the following steps. In a first step, time, measured in units of OFDM symbol periods, is divided into pre-determined and fixed beacon periods. In a second step, when the BS 304 seeks to communicate data to the receiver, it waits to the next beacon opportunity, and announces its intention by sending a special Golay sequence using Algorithm 1, which can be called a “beacon.” This is a special and fixed signal intended to be easily detected with low signal-to-noise-ratio (e.g., by a receiver with a small number of low-cost antenna elements) as regular data may require higher signal-to-noise ratio (e.g., the receiver may need all the antenna elements active to receive regular data). In a third step, the receiver activates a pre-determined subset of antenna elements for one symbol every beacon period. If the receiver detects a beacon, it activates all the remaining antenna elements for an additional symbol, which is employed by the BS to send data using Algorithm 1. In an embodiment, there can be an interval in between beacon and data exchange. In a fourth step, after the symbol selected to exchange data, the receiver deactivates its antenna elements until the next beacon period. In an embodiment, a method that enables a 5G BS to send configuration commands wirelessly to a RIS using the first method of the first step and the protocol of the second method/second step.

Embodiments of the present disclosure provide for the following improvements and technical advantages over existing technology including: 1) a method to disguise RIS control messages into New Radio OFDM symbols in a way that the RIS 302 can decode without active radio-frequency chains or other communication technologies and/or 2) a method such that the BSs 304 can synchronize its radio scheduler decisions and the optimization of the RIS configuration seamlessly, without third-party interfaces. Based on utilizing embodiments of the present disclosure, advantages can be achieved such as, but not limited to, the RIS 302 might not require external communication technologies or active radio-frequency antennas, the BS 304 might not require external communication technologies, only its 3GPP-compliant New Radio pipelines, and/or the BS 304 can jointly schedule radio resources and configure the RIS 302 at the same time.

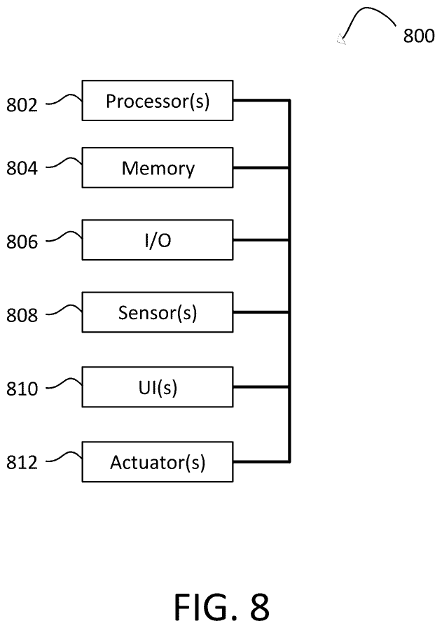

Referring to FIG. 8, a processing system 800 can include one or more processors 802, memory 804, one or more input/output devices 806, one or more sensors 808, one or more user interfaces 810, and one or more actuators 812. Processing system 800 can be representative of each computing system disclosed herein.

Processors 802 can include one or more distinct processors, each having one or more cores. Each of the distinct processors can have the same or different structure. Processors 802 can include one or more central processing units (CPUs), one or more graphics processing units (GPUs), circuitry (e.g., application specific integrated circuits (ASICs)), digital signal processors (DSPs), and the like. Processors 802 can be mounted to a common substrate or to multiple different substrates.

Processors 802 are configured to perform a certain function, method, or operation (e.g., are configured to provide for performance of a function, method, or operation) at least when one of the one or more of the distinct processors is capable of performing operations embodying the function, method, or operation. Processors 802 can perform operations embodying the function, method, or operation by, for example, executing code (e.g., interpreting scripts) stored on memory 804 and/or trafficking data through one or more ASICs. Processors 802, and thus processing system 800, can be configured to perform, automatically, any and all functions, methods, and operations disclosed herein. Therefore, processing system 800 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 800 can be configured to perform task “X”. Processing system 800 is configured to perform a function, method, or operation at least when processors 802 are configured to do the same.

Memory 804 can include volatile memory, non-volatile memory, and any other medium capable of storing data. Each of the volatile memory, non-volatile memory, and any other type of memory can include multiple different memory devices, located at multiple distinct locations and each having a different structure. Memory 804 can include remotely hosted (e.g., cloud) storage.

Examples of memory 804 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 804.

Input-output devices 806 can include any component for trafficking data such as ports, antennas (i.e., transceivers), printed conductive paths, and the like. Input-output devices 806 can enable wired communication via USB®, DisplayPort®, HDMI®, Ethernet, and the like. Input-output devices 806 can enable electronic, optical, magnetic, and holographic, communication with suitable memory 804. Input-output devices 806 can enable wireless communication via WiFi®, Bluetooth®, cellular (e.g., LTE®, CDMA®, GSM®, WiMax®, NFC®), GPS, and the like. Input-output devices 806 can include wired and/or wireless communication pathways.

Sensors 808 can capture physical measurements of environment and report the same to processors 802. User interface 810 can include displays, physical buttons, speakers, microphones, keyboards, and the like. Actuators 812 can enable processors 802 to control mechanical forces.

Processing system 800 can be distributed. For example, some components of processing system 800 can reside in a remote hosted network service (e.g., a cloud computing environment) while other components of processing system 800 can reside in a local computing system. Processing system 800 can have a modular design where certain modules include a plurality of the features/functions shown in FIG. 8. For example, I/O modules can include volatile memory and one or more processors. As another example, individual processor modules can include read-only-memory and/or local caches.

Embodiments of the present disclosure can be implemented as a computer-implemented method, computer system (comprising one or more processors and one or more storage devices) configured to perform the computer-implemented method and/or as a computer program for performing the computer-implemented method. For example, the computer-implemented method can include one or more steps and/or operations discussed above.

Examples may involve or relate to computer programs, including program codes to execute one or more of the mentioned methods when the program is executed on a computer, processor, or other programmable hardware component. As a result, steps, operations, or processes from various methods described above can also be executed by computers, processors, or other programmable hardware components. Examples may additionally cover program storage devices, such as digital data storage media, which are machine-, processor-, or computer-readable and encode and/or contain machine-executable, processor-executable, or computer-executable programs and instructions. These devices may include or be digital storage devices, magnetic storage media like magnetic disks and tapes, hard disk drives, or optically readable digital data storage media, for instance. Other examples encompass computers, processors, control units, field programmable logic arrays (FPLAs), field programmable gate arrays (FPGAs), graphics processing units (GPUs), application-specific integrated circuits (ASICs), integrated circuits (ICs), or system-on-a-chip (SoC) systems that are programmed to carry out the steps of the aforementioned methods. In simpler terms, examples may involve computer programs and storage media comprising computer programs, as well as hardware components like processors and control units, which can be programmed to execute the methods described above.

When certain aspects are mentioned in relation to a device or system, they should also be considered as descriptions of the corresponding methods. For example, a block, component, or functional aspect of the device or system may correspond to a method step or feature of the related method. Therefore, aspects described regarding a method should also be understood as depicting a corresponding element, property, or functional feature of the corresponding device or system. In simpler terms, if something is described in relation to a device or system, it can also be applied to the corresponding method, and vice versa.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications can be made, by those of ordinary skill in the art, within the scope of the following claims, which can include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for enabling a base station (BS) to provide configuration commands wirelessly to a reconfigurable intelligence surface (RIS), comprising:
establishing a new codebook for each configuration from a previous set of configurations;
generating an RIS control message based on embedding amplitude-modulated (AM) signals into Orthogonal Frequency-Division Multiplexing (OFDM) signals using the new codebook; and
providing the RIS control message to the RIS to control the RIS.

2. The computer-implemented method of claim 1, wherein the BS is a fifth-generation wireless cellular (5G) BS and the RIS comprises an energy receiver, and wherein providing the RIS control message to the RIS comprises providing, by the 5G BS, the RIS control message to the energy receiver of the RIS.

3. The computer-implemented method of claim 1, wherein establishing the new codebook comprises:
selecting a pulse based on a pulse width, a number of bits, and an OFDM symbol duration; and
generating new configurations for the new codebook based on the selected pulse and the previous set of configurations.

4. The computer-implemented method of claim 3, wherein generating the new configurations comprises:
determining an On-Off Keying (OOK) signal for a first configuration from the previous set of configurations based on the selected pulse;
determining new frequency-domain OFDM symbols based on the OOK signal for the first configuration; and
storing the new frequency-domain OFDM symbols for the first configuration within the new codebook.

5. The computer-implemented method of claim 4, wherein determining the new frequency-domain OFDM symbols comprises:
sampling the OOK signal and performing a K-point Discrete Fourier Transform (DFT) to obtain a discrete representation of the OOK signal; and
determining the new frequency-domain OFDM symbols based on performing a mean square error using the discrete representation of the OOK signal.

6. The computer-implemented method of claim 1, wherein establishing the new codebook comprises:
generating the new codebook based on the previous set of configurations;
duplicating the new codebook; and
prior to generating the RIS control message, providing the duplicated new codebook to the RIS.

7. The computer-implemented method of claim 1, further comprising:
based on the RIS control message, decoding, by the RIS, information associated with the RIS control message to obtain a bit sequence;
converting, by the RIS, the bit sequence into a unique identifier; and
loading, by the RIS, phase shift configurations into phase shifters of the RIS based on the unique identifier and the new codebook.

8. The computer-implemented method of claim 1, further comprising:
determining a pre-agreed time interval to provide the RIS control message, and wherein providing the RIS control message to the RIS to control the RIS is based on the pre-agreed time interval.

9. The computer-implemented method of claim 1, wherein providing the RIS control message to the RIS to control the RIS is based on using a beacon signal to minimize a time duration that a multi-antenna receiver of the RIS devotes to obtaining the RIS control message.

10. The computer-implemented method of claim 9, wherein the time duration is associated with units of OFDM symbol periods, and wherein providing the RIS control message to the RIS to control the RIS comprises:
dividing the time duration into pre-determined and fixed beacon periods;
providing the beacon signal at a next beacon period indicated by the pre-determined and fixed beacon periods; and
providing the RIS control message to the RIS at an additional symbol period that is subsequent to the next beacon period.

11. The computer-implemented method of claim 10, wherein the method further comprises:
generating the beacon signal using a Golay sequence and a generation algorithm, wherein the beacon signal is detectable by the multi-antenna receiver of the RIS with a number of antenna elements that is below a pre-determined threshold, wherein the pre-determined threshold is associated with a signal-to-noise ratio (SNR).

12. The computer-implemented method of claim 1, wherein the RIS comprises a plurality of antenna elements, and wherein the method further comprises:
activating, by the RIS, a pre-determined subset of the plurality of antenna elements for one symbol every beacon period;
based on detecting a beacon signal provided by the BS during the one symbol, activating, by the RIS, remaining antenna elements from the plurality of antenna elements during an additional symbol, and wherein the BS provides the RIS control message to the RIS during the additional symbol.

13. The computer-implemented method of claim 12, wherein one or more symbols are between the one symbol for detecting the beacon signal and the additional symbol for the RIS control message.

14. A computer system for enabling a base station (BS) to provide configuration commands wirelessly to a reconfigurable intelligence surface (RIS), the computer system comprising one or more hardware processors, which, alone or in combination, are configured to provide for execution of the following steps:
establishing a new codebook for each configuration from a previous set of configurations;
generating an RIS control message based on embedding amplitude-modulated (AM) signals into Orthogonal Frequency-Division Multiplexing (OFDM) signals using the new codebook; and
providing the RIS control message to the RIS to control the RIS.

15. A tangible, non-transitory computer-readable medium having instructions thereon which, upon being executed by one or more processors, alone or in combination, provide for execution of a method for enabling a base station (BS) to provide configuration commands wirelessly to a reconfigurable intelligence surface (RIS) comprising the following steps:
establishing a new codebook for each configuration from a previous set of configurations;
generating an RIS control message based on embedding amplitude-modulated (AM) signals into Orthogonal Frequency-Division Multiplexing (OFDM) signals using the new codebook; and
providing the RIS control message to the RIS to control the RIS.
